(19) United States
(12) Patent Application Publication
(10) Pub. No.: US 2026/0025901 A1
(43) Pub. Date: Jan. 22, 2026

(54) METHOD AND LASER SYSTEM FOR GENERATING SECONDARY RADIATION

(71) Applicant: TRUMPF Laser AG, Schramberg (DE)

(72) Inventors: Torsten Mans, Aachen (DE); Marc Sailer, Schramberg (DE); Max Kahmann, Nufringen (DE); Daniel Flamm, Ludwigsburg (DE)

(21) Appl. No.: 19/339,346

(22) Filed: Sep. 25, 2025

Related U.S. Application Data
(63) Continuation of application No. PCT/EP2024/058142, filed on Mar. 26, 2024.

(30) Foreign Application Priority Data
Mar. 27, 2023 (DE) 10 2023 107 702.3

(51) Int. Cl. H05G 2/00

(52) U.S. Cl. CPC H05G 2/0088; H05G 2/0084

(57) ABSTRACT

A method for generating secondary radiation includes providing a target material in a target region, and applying a pulse sequence of laser pulses to the target material in the target region. Secondary radiation is generated as a result of interaction of the target material with the pulse sequence. The pulse sequence has a pulse train of at least two pre-pulses and a main pulse following the pulse train. A total energy of the pre-pulses of the pulse train is between 0.2 mJ and 10 mJ. A temporal pulse interval between successive pre-pulses of the pulse train is between 50 ps and 500 ns. A pulse energy of the main pulse is between 2 mJ and 50 mJ. A pulse duration of the main pulse is between 15 fs and 300 fs. A temporal pulse interval between the pulse train and the main pulse is between 1 ns and 1 μs.

### CROSS REFERENCE TO RELATED APPLICATIONS

This application is a continuation of International Application No. PCT/EP2024/058142 (WO 2024/200458 A1), filed on Mar. 26, 2024, and claims benefit to German Patent Application No. DE 10 2023 107 702.3, filed on Mar. 27, 2023. The aforementioned applications are hereby incorporated by reference herein.

### FIELD

Embodiments of the present invention relate to a method and a laser system for generating secondary radiation.

### BACKGROUND

US2018317309 A1 discloses a method for generating EUV light, wherein a droplet of target material is reshaped by irradiation with a first pre-pulse laser beam, a seed plasma is generated by irradiating the reshaped droplet with a second pre-pulse laser beam, and EUV light is generated by heating the seed plasma with a main pulse laser beam.

US2018206318 A1 discloses a modular plasma X-ray system comprising a liquid metal flow system enclosed in a low-pressure chamber, wherein the flow system contains a liquid metal and wherein a metal target irradiable by laser pulses is formed at at least one location on the liquid metal, a circulation pump within the liquid metal flow system for circulating the liquid metal, a laser pulse emitter configured to emit laser pulses into the chamber via a laser window, focusing optics located between the emitter and the metal target, the focusing optics directing the laser pulses such that they strike the metal target at a target location to form X-ray pulses, and an X-ray window positioned within the chamber through which the X-ray pulses exit the chamber.

WO 2014044392 A1 discloses an EUV radiation generation device comprising a vacuum chamber in which a target material can be arranged at a target position for generating EUV radiation, and a beam-directing chamber for directing a laser beam from a driver laser device in the direction of the target position. An intermediate chamber is provided which is mounted between the vacuum chamber and the beam-directing chamber; also provided are a first window which seals the intermediate chamber in a gas-tight manner for entry of the laser beam from the beam-directing chamber, and a second window which seals the intermediate chamber in a gas-tight manner for exit of the laser beam into the vacuum chamber.

### SUMMARY

Embodiments of the present invention provide a method for generating secondary radiation. The method includes providing a target material in a target region, and applying a pulse sequence of laser pulses to the target material in the target region. Secondary radiation is generated as a result of interaction of the target material with the pulse sequence. The pulse sequence has a pulse train of at least two pre-pulses and a main pulse following the pulse train. A total energy of the pre-pulses of the pulse train is between 0.2 mJ and 10 mJ. A temporal pulse interval between successive pre-pulses of the pulse train is between 50 ps and 500 ns. A pulse energy of the main pulse is between 2 mJ and 50 mJ. A pulse duration of the main pulse is between 15 fs and 300 fs. A temporal pulse interval between the pulse train and the main pulse is between 1 ns and 1 μs.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary embodiment of a laser system;

FIG. 2a, FIG. 2b and FIG. 2c show a first example for generating secondary radiation, wherein an indentation is generated in the target material by means of a pulse train of pre-pulses according to some embodiments; and

FIG. 3a, FIG. 3b and FIG. 3c show a further example of generating secondary radiation, wherein nanoparticles are generated in the region of the surface of the material by means of a pre-pulse according to some embodiments.

### DETAILED DESCRIPTION

Embodiments of the invention provide a method and a laser system that can enable the generation of secondary radiation with increased efficiency.

According to embodiments of the invention, a target material is provided in a target region, a pulse sequence of laser pulses is applied to the target material in the target region, wherein secondary radiation is generated as a result of interaction of the target material with the pulse sequence, wherein the pulse sequence has a pulse train of at least two pre-pulses and a main pulse following the pulse train, a total energy of the pre-pulses of the pulse train is between 0.2 mJ and 10 mJ and a temporal pulse interval between successive pre-pulses of the pulse train is between 50 ps and 500 ns, a pulse energy of the main pulse is between 2 mJ and 50 mJ and a pulse duration of the main pulse is between 15 fs and 300 fs and wherein a temporal pulse interval between the pulse train and the main pulse is between 1 ns and 1 μs.

By applying the pulse train of pre-pulses to the target material, the nature and/or state of the target material is/are changed in such a way that interaction of the main pulse with the target material and in particular its absorption by the target material may take place particularly efficiently. By means of the pre-pulses, in particular a geometric nature and/or geometric structure of a surface of the target material is changed in order to improve the efficiency of the interaction or absorption of the main pulse. The preparation of the target material with the pre-pulses of the pulse train before the arrival of the main pulse thus enables particularly efficient generation of secondary radiation.

The interaction of the laser pulses of the pulse sequence with the target material is or includes in particular at least partial absorption of the laser pulses by the target material. In particular, the laser pulses of the pulse sequence are at least partially absorbed by the target material.

The fact that the main pulse follows the pulse train of at least two pre-pulses should be understood to mean that the at least two pre-pulses of the pulse train strike the target material before the main pulse does. It is therefore the pre-pulses that hit the target material first, followed by the main pulse.

The secondary radiation generated by the method according to embodiments of the invention is in particular electromagnetic radiation with a quantum energy of between 0.5 keV and 100 keV and preferably of between 5 keV and 50 keV. In particular, the method according to embodiments of the invention is suitable for generating electromagnetic radiation with a quantum energy in the above-mentioned ranges. In particular, the secondary radiation generated is X-ray radiation.

In particular, the laser pulses of the pulse sequence have a wavelength of between 300 nm and 10 μm. Preferably, the wavelength is in a range between 330 nm and 350 nm, between 500 nm and 550 nm, between 0.8 μm and 1.2 μm, between 1.5 μm and 2.5 μm, or between 9 μm and 11 μm. In particular, all the laser pulses in the pulse sequence have the same wavelength.

It may be advantageous for the total energy of the pre-pulses of the pulse train to be between 0.5 mJ and 5 mJ and in particular between 0.8 mJ and 1.2 mJ. By means of the pre-pulses of the pulse train, the geometric nature and/or geometric structure of the target material may be changed in such a way that interaction or absorption of the main pulse on the target material occurs with particularly high efficiency.

For the same reason, it may be advantageous for the temporal pulse interval between successive pre-pulses of the pulse train to be between 100 ps and 100 ns and in particular between 200 ps and 0.5 ns.

For the same reason, it may be advantageous for the total temporal length of the pulse train of pre-pulses to be between 1 ns and 10 μs.

In particular, application of the pulse train of at least two pre-pulses to the target material causes the formation of an indentation in the target material. The indentation is positioned in particular on a surface and/or in a spatial region of the target material at which or in which the pulse train of at least two pre-pulses is applied to the target material. The indentation formed on the surface of the target material results in increased efficiency of interaction or absorption of the main pulse on the target material in order to generate secondary radiation.

In particular, the surface forms a boundary surface and/or phase boundary of the target material.

It may be advantageous for the pulse energy of the main pulse to be between 5 mJ and 15 mJ and in particular between 8 mJ and 12 mJ. This makes it possible, for example, to generate secondary radiation in the form of X-rays with particularly high efficiency.

For the same reason, it may be advantageous for the pulse duration of the main pulse to be between 25 fs and 50 fs.

In particular, it may be provided that all the laser pulses of the pulse sequence are applied to the target material at the same location and/or in the same spatial region of the target material. This results in the aforementioned increase in efficiency in the generation of secondary radiation.

In particular, the spatial region in which the laser pulses of the pulse sequence strike the target material has a maximum spatial extent, in particular maximum diameter, of at least 2.5 μm and/or at most 30 μm and in particular at least 3 μm and/or at most 15 μm.

In particular, the laser pulses of the pulse train approach the target material at a velocity that is much greater than a movement velocity and/or flow velocity of the target material within the target region, such that all the laser pulses of the pulse train strike the target material at approximately the same location and/or in the same spatial region.

In particular, the main pulse is applied to the target material in a spatial region and/or in the same spatial region in which an indentation has been formed on a surface of the target material by means of the pulse train of at least two pre-pulses. In particular, the main pulse then strikes the indentation formed on the surface of the target material.

It may be provided that an impact position of the respective laser pulses of the pulse sequence on the target material is adjusted such that all the laser pulses of the pulse sequence strike the target material at the same location and/or in the same spatial region. For this purpose, for example, a control device may be provided.

For example, the impact position is adjusted such that the main pulse strikes the indentation formed on the surface of the target material, which indentation was formed there by the pulse train of at least two pre-pulses.

It may be advantageous for a negative pressure and/or a vacuum and/or a gas atmosphere with a defined composition to be formed in the target region.

In particular, it may be provided that the laser pulses of the pulse sequence are assigned to at least one primary laser beam, wherein the at least one primary laser beam is provided by means of a laser device and is directed toward the target region in order to interact there with the target material. The laser pulses of the pulse sequence are applied to the target material by means of the at least one primary laser beam.

In particular, a single primary laser beam may be provided to which the laser pulses of the pulse sequence are assigned. For example, this primary laser beam is then formed by coaxial superimposition of a plurality of laser beams, each of which provides one or more laser pulses of the pulse sequence.

In principle, it is also possible to provide a plurality of primary laser beams directed at the target region in order to interact with the target material in the target region. In particular, the primary laser beams then run at a distance from each other and/or approach the target region from different directions. In particular, one or more laser pulses of the pulse sequence is/are then assigned to the different primary laser beams.

In particular, it may be provided that the at least one primary laser beam is focused into the target region, wherein a focus of the primary laser beam is positioned in the target material and/or on the target material and/or in a region of the target material. A highest possible radiation intensity may be provided in the focus and caused to interact with the target material.

The focus of the at least one primary laser beam has in particular a diameter in the range of 2.5 μm to 30 μm and preferably in the range of 3 μm to 15 μm.

It may be advantageous for target material to be continuously fed and/or conveyed into the target region. This ensures that fresh target material is continuously available in the target region, which may be caused to interact with the pulse sequence to generate secondary radiation. This allows for secondary radiation to be continuously generated.

The target material is preferably in a liquid state. In particular, the target material is or comprises a low-melting metal. For example, the target material is or comprises gallium, indium, tin, zinc, lithium, bismuth or lead, or an alloy comprising one or more of the stated materials.

In particular, the target material passes through the target region as a material stream and in particular as a liquid material stream. In particular, the target material passes through the target region at a specific flow velocity and/or delivery rate.

The material stream may be continuous, e.g., in the form of a jet, or have interruptions, e.g., in the form of successive drops.

A flow direction of the material stream is oriented in particular parallel to the direction of gravity. In particular, the flow direction is oriented transversely of or perpendicularly to the direction of movement of the laser pulses of the pulse sequence and/or perpendicularly to the propagation direction of at least one primary laser beam to which the laser pulses of the pulse sequence are assigned.

For example, a flow velocity, oriented parallel to the flow direction, of the target material in the target region is between 60 m/s and 120 m/s.

It may be advantageous for the pulse sequence of laser pulses to be repeatedly newly provided and introduced into the target region, wherein a newly provided pulse sequence of laser pulses is in each case applied to target material newly introduced into the target region. This allows for secondary radiation to be continuously generated.

In particular, the pulse sequence of laser pulses is newly provided at time intervals and, in particular, at regular time intervals.

In a variant of the method, it may be provided that the pulse sequence of laser pulses has a further pre-pulse which is arranged between the pulse train of at least two pre-pulses and the main pulse, wherein the further pre-pulse has a pulse duration of between 200 fs and 5 ps and a pulse energy of between 2 uJ and 200 uJ. This allows the efficiency of the interaction and in particular the absorption of the main pulse at the target material to be further increased.

In this case, a pre-pulse is understood to mean a pre-pulse of a first type or with first pulse properties, and the further pre-pulse is understood to mean a pre-pulse of a second type or with second pulse properties.

The fact that the further pre-pulse is arranged between the pulse train of at least two pre-pulses is understood to mean that the further pre-pulse is positioned chronologically between the pre-pulses of the pulse train and the main pulse and consequently strikes the target material chronologically between the pre-pulses of the pulse train and the main pulse. It is therefore the pre-pulses that strike the target material first, followed by the further pre-pulse and then the main pulse.

It may be provided that the pulse sequence has a plurality of further pre-pulses or a pulse train of a plurality of further pre-pulses, wherein the further pre-pulses or the pulse train are positioned between the pulse train of at least two pre-pulses and the main pulse.

For the stated reason, it may be advantageous for the pulse duration of the further pre-pulse to be between 800 fs and 1.5 ps.

For the stated reason, it may be advantageous for the pulse energy of the further pre-pulse to be between 5 μJ and 100 μJ.

For the stated reason, it may be advantageous for the temporal pulse interval between the further pre-pulse and the main pulse to be between 1 ps and 1 ns and in particular between 10 ps and 100 ps.

For the stated reason, it may be advantageous for the temporal pulse interval between the further pre-pulse and the pulse train of pre-pulses to be between 0.5 ns and 500 ns and in particular between 20 ns and 200 ns.

In particular, application of the further pre-pulse to the target material causes the formation of nanoparticles. In particular, the nanoparticles are positioned in the region of a surface and/or in a spatial region of the target material in which the further pre-pulse is applied to the target material. The nanoparticles formed in the region of the surface of the target material result in increased efficiency of interaction or absorption of the main pulse on the target material in order to generate secondary radiation.

In particular, the region in which the nanoparticles are positioned extends from the surface of the target material to a distance of 50 μm from the surface.

In particular, the nanoparticles are positioned in the spatial region in which an indentation formed by the pulse train in the form of pre-pulses is formed on the surface of the target material.

According to embodiments of the invention, the above-mentioned laser system comprises a laser device which is configured to provide a pulse sequence of laser pulses, wherein the pulse sequence has a pulse train of at least two pre-pulses and a main pulse following the pulse train, a total energy of the pre-pulses of the pulse train is between 0.2 mJ and 10 mJ and a temporal pulse interval between successive pre-pulses of the pulse train is between 50 ps and 500 ns, a pulse energy of the main pulse is between 2 mJ and 50 mJ and a pulse duration of the second laser pulse is between 15 fs and 300 fs and wherein a temporal pulse interval between the pulse train and the main pulse is between 1 ns and 1 μs. The laser system is configured to apply the pulse sequence of laser pulses to a target material in a target region, wherein secondary radiation is generated by interaction of the target material with the pulse sequence.

The laser system according to embodiments of the invention in particular has one or more further features and/or advantages of the method according to embodiments of the invention. Advantageous embodiments of the laser system have already been explained in connection with the method.

The method according to embodiments of the invention may be carried out in particular by means of the laser system according to embodiments of the invention. In particular, the method according to embodiments of the invention is carried out by means of the laser system according to embodiments of the invention.

In particular, the laser device provides at least one primary laser beam, to which the laser pulses of the pulse sequence are assigned, wherein the at least one primary laser beam is directed onto the target material located in the target region. The at least one primary laser beam includes the laser pulses of the pulse sequence applied to the target material.

The laser device comprises in particular one or more laser sources for providing the laser pulses of the pulse sequence. For example, a respective laser source provides a primary laser beam with laser pulses of a specific type and/or specific properties.

In particular, the respective primary laser beams, which are provided by different laser beam sources, are superimposed to form a resulting primary laser beam and in particular are superimposed coaxially, wherein the laser pulses of the pulse sequence are assigned to the resulting primary laser beam.

In particular, the laser system comprises focusing optics for focusing the at least one primary laser beam into a focus, wherein the focus is positioned in the target region in the target material and/or on the target material and/or in a region of the target material.

In particular, it may be provided that the laser system has a control device for open- and/or closed loop control of a beam length of the at least one primary laser beam. Preferably, the control device is designed to provide open- or closed-loop control of a position of the at least one primary laser beam and in particular its focus within the target region and/or an impact position of the primary laser beam on the target material within the target region.

In particular, it may be provided that the laser system comprises the target region and/or comprises the target material.

In the context of the present application documents, diameters of laser beams and/or focus diameters are in principle defined using the second-moment method according to ISO 11146-3. Pulse durations are defined in particular by the half-width of the deconvolved autocorrelation.

In particular, the statement “at least approximately” is generally understood to mean a deviation of no more than 10%, i.e., that an actual value deviates from an ideal value by no more than 10%.

Identical or functionally equivalent elements are provided with the same reference signs in all the figures.

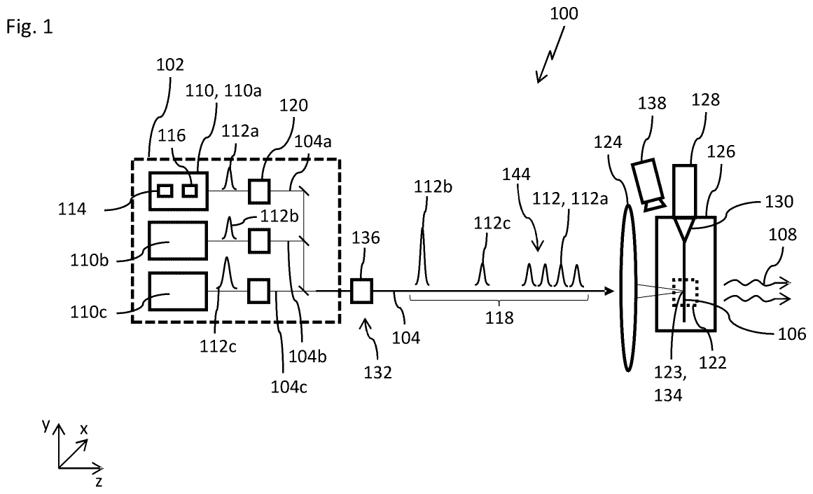

An exemplary embodiment of a laser system is shown in FIG. 1 and is designated therein by 100. The laser system 100 comprises a laser device 102, by means of which at least one pulsed primary laser beam 104 is provided during operation of the laser system 100. This primary laser beam 104 is directed onto a target material 106, wherein secondary radiation 108 is generated through interaction of the primary laser beam 104 with the target material 106.

The target material 106 is or comprises, for example, gallium, indium, tin, zinc, lithium, bismuth, or alloys of these metals.

The laser device 102 is configured to provide the pulsed primary laser beam 104 with laser pulses 112 having different properties and pulse intervals. For this purpose, the laser device 102 comprises, for example, a plurality of laser sources 110, each of which generates pulsed laser beams with different properties. In the example shown, the respective pulsed laser beams of these laser sources 110 are coaxially superimposed to form the pulsed primary laser beam 104 emerging from the laser device 102.

The laser device 102 comprises, for example, a first laser source 110a, which provides a first pulsed primary laser beam 104a with laser pulses 112a, a second laser source 110b, which provides a second pulsed primary laser beam 104b with laser pulses 112b, and a third laser source 110c, which provides a third pulsed primary laser beam 104c with laser pulses 112c.

The first primary laser beam 104a, second primary laser beam 104b and third primary laser beam 104c emerging from the laser device 102 are coaxially superimposed in the example shown and, in particular, have the same beam path after emerging from the laser device 102. In the example shown, the primary laser beam 104 is thus formed from the first primary laser beam 104a, second primary laser beam 104b and third primary laser beam 104c or comprises the first primary laser beam 104a, second primary laser beam 104b and third primary laser beam 104c.

Alternatively, it is also possible in principle for the different primary laser beams 104a, 104b, 104c to have different beam paths after emerging from the laser device 102 and/or to run at a distance from one another before they strike the target material 106. In this case, in particular, no coaxial superimposition of the different primary laser beams 104a, 104b, 104c takes place.

A respective laser source 110 comprises, for example, a seed laser 114 for generating seed laser pulses and an amplification device 116, which generates the respective laser pulses 112a, 112b, 112c of the primary laser beams 104a, 104b, 104c by amplifying the seed laser pulses (indicated at the laser source 110a in FIG. 1).

The amplification device 116 may comprise simple amplifiers, regenerative amplifiers and/or multipass amplifiers. For example, the amplification device 116 may comprise fiber, rod, rod-type fiber, disc, slab, multi-slab and/or plate amplifiers.

Alternatively, it is also possible, for example, for a plurality of or all the laser sources 110 present to be assigned a common amplification device 116. In particular, a plurality of or all the laser sources 110 then use the same amplification device 116. In this case, for example, the laser pulses generated by different seed lasers 114 of the laser sources 110 are amplified by means of the same amplification device 116 in order to form the respective laser pulses 112a, 112b, 112c of the primary laser beams 104a, 104b, 104c.

The laser device 102 is configured to couple out the laser pulses 112 provided by the different laser sources 110 in a defined chronological sequence and/or with a defined time offset in order to apply the laser pulses 112 to the target material 106 in this chronological sequence or with this defined time offset. These laser pulses 112 form a pulse sequence 118 which is applied to the target material 106 to generate secondary radiation 108.

The laser radiation associated with the laser pulses 112 has, for example, a wavelength of 10 μm, 3 μm, 515 nm or 343 nm.

In order to couple out the laser pulses 112 provided by the different laser sources 110 in a defined chronological sequence and/or with a defined time offset, it may be provided that the laser device 102 comprises one or more optical modulators 120 and/or optical switches. For example, a modulator 120 is assigned in each case to the different laser sources 110 of the laser device 102. During operation of the laser system 100, the respective modulator 120 is used to select laser pulses 112 for coupling out from the laser device 102 and/or to set time intervals between the coupled-out laser pulses.

The optical modulator 120 may be designed, for example, as an acousto-optical modulator and/or as an electro-optical modulator.

As shown in FIG. 1, the modulators 120 are, for example, each arranged downstream of a specific laser beam source 110. It is also possible in principle for the modulators 120 in each case to be integrated into a specific laser beam source 110 and to be arranged there, for example, between the seed laser 114 and the amplifier 116.

Alternatively or additionally, a specific chronological sequence and/or a specific time offset between the coupled-out laser pulses 112 may be achieved by a defined path length difference and/or transit time difference, which the individual laser pulses 112 exhibit relative to one another from the respective laser source 110 until they reach the target material 106. The path length difference may be achieved, for example, via electronic and/or optical delay lines (not shown), wherein a delay line may be inserted into the respective beam path of one or more of the primary laser beams 104a, 104b, 104c present. Optical delay lines may generally be free-beam- or fiber-based.

The laser system 100 has a target region 122 in which the target material 106 is arranged in order for the primary laser beam 104 to be applied to said target material and for said target material to interact with the laser pulses 112 thereof. It is essential for target material 106 to be fed continuously into the target region 122, such that fresh target material 106, to which in particular the primary laser beam 104 has not yet been applied, is always available for generating secondary radiation 108. This enables continuous generation of secondary radiation 108 during operation of the laser system 100.

In particular, the pulsed primary laser beam 104 directed onto the target material 106 is focused into a focus 123, wherein the focus 123 is arranged in the target region 122 in and/or on the target material 106. Focusing optics 124 may, for example. be provided for this purpose.

The target region 122 is understood to be a stationary region of the laser system 100 into which the target material 106 is coupled and/or into which the primary laser beam 104 is introduced in order to interact with the target material 106.

The target region 122 is preferably positioned in a fluid-tight and/or gas-tight chamber 126. In this chamber 126, for example, a negative pressure and/or a vacuum and/or a gas atmosphere with a defined composition is formed compared to the environment. For example, the pressure inside the chamber is between 10 mbar and 500 mbar.

For example, the gas arranged in the chamber 126 is or comprises hydrogen and/or helium.

To feed the target material 106 into the target region 122 and convey it through the target region 122, the laser system 100 may have a feed device 128. In particular, the feed device 128 may continuously provide target material 106, which passes through the target region 122 at a certain velocity and/or conveying rate.

In particular, the target material 106 is provided by means of the feed device 126 as a liquid material stream which passes through the target region 122. This material stream is preferably in the form of a jet and in particular in the form of a continuous and/or uninterrupted jet. However, the material stream may also be in the form of successive and/or mutually spaced droplets. The feed device 126 has, for example, a nozzle 128, by means of which the target material 106 is accordingly dispensed.

In the example shown in FIG. 1, the direction of gravity is oriented in the negative y-direction, such that target material 106 delivered by the feed device 126 passes through the target region 122 in the direction of gravity (i.e., in the negative y-direction or from top to bottom).

For example, the target material 106 passes through the target region 122 at a velocity of between 60 m/s and 120 m/s.

It is also possible in principle for the liquid material stream of target material 106 provided by the feed device 126 to be in the form of a film which is formed on a suitable material surface (not shown) and passes through the target region 122. For this purpose, the feed device 126 may, for example, comprise a movable mechanism (not shown), such as a rotating wheel, a rotating drum, a rotating ball or a moving belt, on the surface of which the film is formed.

Further technical details regarding the provision of target material for generating secondary radiation by interaction with a primary laser beam are described, for example, in the scientific publication “Light sources for high-volume manufacturing EUV lithography: technology, performance, and power scaling”, I. Fomenkov et al., Advanced Optical Technologies 6(3): 173-186, DOI: 10.1515/aot-2017-0029.

It may be provided that the laser system 100 has a control device 132 for open- and/or closed-loop control of a beam length of the primary laser beam 104. This control device 132 is designed in particular to open- or closed-loop control a position of the primary laser beam 104 and in particular its focus 123 within the target region 122 and/or an impact position 134 of the primary laser beam 104 on the target material 106 within the target region 122.

For spatial displacement of the primary laser beam 104, the control device 132 comprises a beam deflection device 136. This may, for example, include movable mirror elements, acousto-optical deflectors and/or electro-optical deflectors to bring about the displacement.

Furthermore, the control device 132 may have a detection device 138 which is configured to detect a local position of a specific feature, wherein the feature is arranged or formed on or in the region of the target material 106. For example, the feature is a geometric feature formed on the target material 106, such as an indentation for example (see below). To detect a specific feature, the detection device 138 may comprise a camera for detecting the feature, for example, by means of image recognition.

The beam deflection device 136 is then configured to open and/or closed-loop control displacement of the primary laser beam 104 by means of the beam deflection device 136 on the basis of the information provided by the detection device 138. For this purpose, the detection device 138 is connected with signaling effect to the beam deflection device 136.

The laser system 100 functions as follows:

During operation of the laser system 100, a pulse sequence 118 is provided by the laser device 102 and caused to interact with target material 106 located in the target region 122 in order to generate secondary radiation 108.

Target material 106 is continuously conveyed into the target region 106 by means of the feed device 128, such that fresh target material 106 is always available there which passes through the target region 122 in particular in the form of a liquid jet (in the examples shown, the target material 106 passes through the target region 122 parallel to the direction of gravity or in the negative y-direction).

It is provided that a defined pulse sequence 118 is applied in each case to a specific spatial region of the target material 106 conveyed through the target region 122. In this spatial region, the target material 106 interacts in particular with all the laser pulses 112 of the pulse sequence 118. Subsequently, the laser device 102 emits, in particular, a further pulse sequence 118, which is then caused to interact with a further spatial region of subsequently conveyed target material 106, etc. In this way, the process for generating the secondary radiation 106 may be continued continuously.

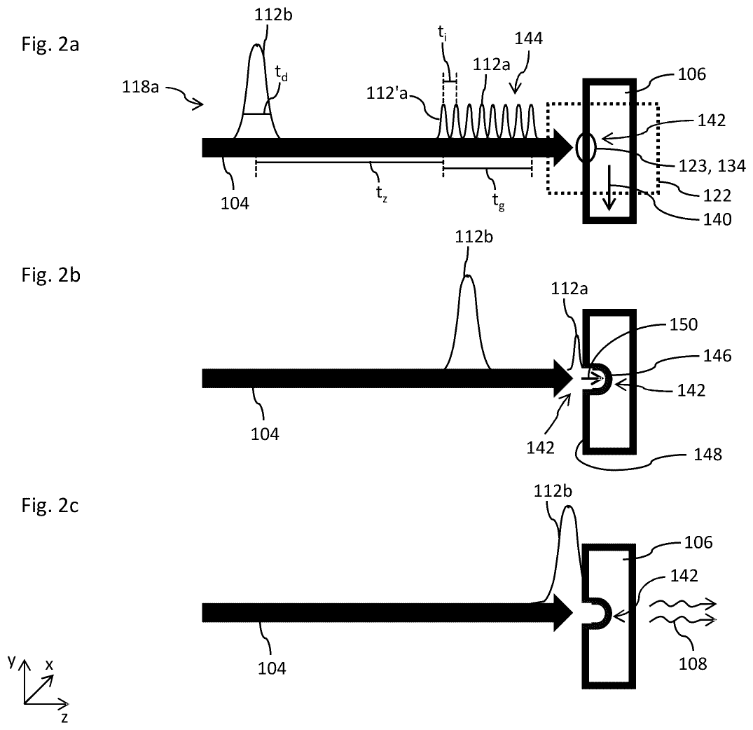

FIGS. 2a to 2c show a chronological sequence of laser pulses 112a, 112b striking the target material 106, these being assigned to a pulse sequence 118a. In the figure shown, the target material 106 flows parallel to a flow direction 140 through the target region 122.

The primary laser beam 104 comprising the laser pulses 112a, 112b or its focus 123 strikes the target material 106 in a specific spatial region 142. This spatial region 142 is to be understood as a spatial region which is fixed relative to the target material 106, and which is assigned to the target material 106 and moves with the target material 106 in the flow direction.

The pulse sequence 118a comprises a pulse train 144 of two or more first laser pulses 112a and a further laser pulse 112b following the pulse train 144. The first laser pulses 112a are also referred to here as pre-pulses and the further laser pulse 112b as the main pulse of the pulse sequence 118a.

The focus 123 of the primary laser beam 104 has in particular a diameter in the range of 2.5 μm to 30 μm. An intensity of the primary laser beam 104 in the focus 123 is, in the case of the main pulse 112b, in particular between 10¹⁶ W/cm² and 10¹⁹ W/cm².

First laser pulses 112a are thus to be understood as laser pulses 112 of a first type and/or with first pulse properties, and second laser pulses 112b are to be understood as laser pulses of a second type and/or with second pulse properties. Accordingly, the third laser pulses 112c are to be understood as laser pulses 112 of a third type and/or with third pulse properties.

The pulse train 144 is to be understood in particular as a burst of first laser pulses 112a. In particular, the pulse train 144 includes at least two and in particular at least 20 and in particular at least 100 first laser pulses 112a.

A temporal pulse interval tᵢ between successive first laser pulses 112a within the pulse train 144 is between 100 ps and 100 ns and preferably between 200 ps and 0.5 ns. In particular, the temporal pulse interval tᵢ between all the neighboring first laser pulses 112a present in the pulse train 144 is at least approximately the same.

A total t_{g} temporal length of the pulse train 144 of first laser pulses 112a is between 1 ns and 10 μs.

The total energy of the pulse train 144 is, for example, between 0.8 mJ and 1.2 mJ. The total energy of the pulse train 144 is understood to be the sum of the pulse energies of all the first laser pulses 112a assigned to the pulse train 144. In particular, all the first laser pulses 112a assigned to the pulse train 144 have at least approximately the same pulse energy.

A temporal pulse interval t_{z} between the pulse train 144 and the second laser pulse 112b is between 10 ps and 1 μs. The temporal pulse interval t_{z} is to be understood as the time interval between the last first laser pulse 112′a of the pulse train 144 and the second laser pulse 112b.

The second laser pulse 112b follows the pulse train 144, i.e., the first laser pulses 112a of the pulse train 144 are the first to strike the target material 106, followed by the second laser pulse 112b.

A pulse duration ta of the second laser pulse 112b is, for example, between 25 fs and 50 fs.

A pulse energy of the second laser pulse 112b is, for example, between 8 mJ and 12 mJ.

The first laser pulses 112a are provided, for example, by means of the first laser source 110a. The first laser source 110a is then configured to provide first laser pulses 112a having the aforementioned properties. Accordingly, the second laser pulses 112b are provided, for example, by means of the second laser source 110b, which is then designed to provide second laser pulses 112b with the aforementioned properties. The described pulse sequence 118a, comprising first and second laser pulses 112a and 112b, may be formed, for example, by means of the optical modulators 120. For this purpose, the optical modulators 120 are used, for example, as pulse pickers and accordingly select the laser pulses provided by the respective laser sources 110a, 110b to form the pulse sequence 118a.

FIG. 2b shows the target material 106 after interaction of a plurality of first laser pulses 112a of the pulse train 144, i.e., the pulse sequence 118a has already been partially caused to interact with the target material 106 and/or absorbed by the target material 106.

The interaction of the pulse train 144 of first laser pulses 112a or pre-pulses causes the formation of an indentation 146 in the target material 106, wherein this indentation is positioned in the region 142 of the target material 106 in which the interaction with the first laser pulses 112a has occurred. The indentation 146 is designed in particular as a “cup” or “dimple”. In principle, it is also possible for the indentation 146 to take the form of a torus and/or a circular trough.

The formation of indentations in materials due to their interaction with laser pulses as well as the underlying physical effects are described, for example, in the scientific publication “Review on Experimental and Theoretical Investigations of Ultra-Short Pulsed Laser Ablation of Metals with Burst Pulses” by Förster et al., Materials 2021, 14, 3331, https://doi.org/10.3390/ma14123331.

In particular, the interaction of the first laser pulses 112a of the pulse train 114 brings about material removal by evaporation and/or melt expulsion.

The indentation 146 is formed on a surface 148 and/or outer side of the target material 106 that is struck by the primary laser beam 104 or the laser pulses 112a, 112b thereof. This surface 148 forms in particular a boundary surface of the target material 106, which in the examples shown is present as a liquid material stream in the form of a jet.

A depth direction 150 of the indentation 146 is oriented at least approximately parallel to the propagation direction of the primary laser beam 104 (indicated by the arrow for the primary laser beam 104) and/or at least approximately perpendicular to the flow direction 140 of the target material 106.

A maximum depth of the indentation 146 oriented parallel to the depth direction 150 with respect to the surrounding surface 148 is, for example, between 5 μm and 150 μm, in particular between 10 μm and 50 μm. A maximum spatial extent and/or a maximum diameter of the indentation 146 is, for example, between 5 μm and 30 μm.

FIG. 2c shows the interaction of the second laser pulse 112b or main pulse with the target material 106 at the formed indentation 146. This interaction generates secondary radiation 108, wherein the generation of secondary radiation may be particularly efficient due to the formed indentation 146. In particular, the indentation is conical and/or parabolic.

The reason for this is in particular improved absorption of the main pulse brought about by the indentation 146, as described, for example, in the scientific publication “Enhancement of hard x-ray emission from a copper target by multiple shots of femtosecond laser pulses” by Hironaka et al., Applied Physics Letters, Volume 74, Number 12, Mar. 22, 1999. In particular, reduced Fresnel reflection may occur, which contributes to the improved absorption.

Furthermore, the geometric shape of the indentation 146 may result in concentration of the radiation intensity of the incident main pulse, as described, for example, in the scientific publication “Development of a bright MeV photon source with compound parabolic concentrator targets on the National Ignition Facility Radiographic Capability (NIF-ARC) laser” by Kerr et al., Phys. Plasmas 30, 013101 (2023), https://doi.org/10.1063/5.0124539.

It is in principle possible for the pulse sequence 118a to have a plurality of second laser pulses 112b in order to generate secondary radiation 108.

Subsequently, to continue the method, a further pulse sequence 118a is generated, which is caused to interact with a new spatial region of subsequently conveyed target material 106, etc. In this way, secondary radiation 108 is continuously generated.

In the method shown in FIGS. 2a, 2b and 2c, all the laser pulses 112a, 112b of the respective pulse sequence 118a interact with the target material 106 in the same spatial region 142. In particular, the first laser pulses 112a of the pulse train 144 interact with the target material 106 in the same spatial region 142 as the second laser pulse 112b. This second laser pulse 112b interacts with the target material 106 in the spatial region 142 in which the indentation 146 is formed.

In particular, a movement velocity of the laser pulses 112a, 112b in the direction of the target material 106 is much greater than the flow velocity of the latter, such that all the laser pulses interact with the target material 106 approximately in the same spatial region 142.

It may be provided that the impact position 134 of the primary laser beam 104 on the target material 106 is adjusted by means of the control device 132 such that it remains constant, in particular between formation of the indentation 146 and impact of the second laser pulse 112b. For this purpose, for example, a spatial position of the formed indentation 146 is determined by means of the detection device 138 and, based thereon, the beam position of the primary laser beam 104 is adjusted by means of the beam deflection device 136.

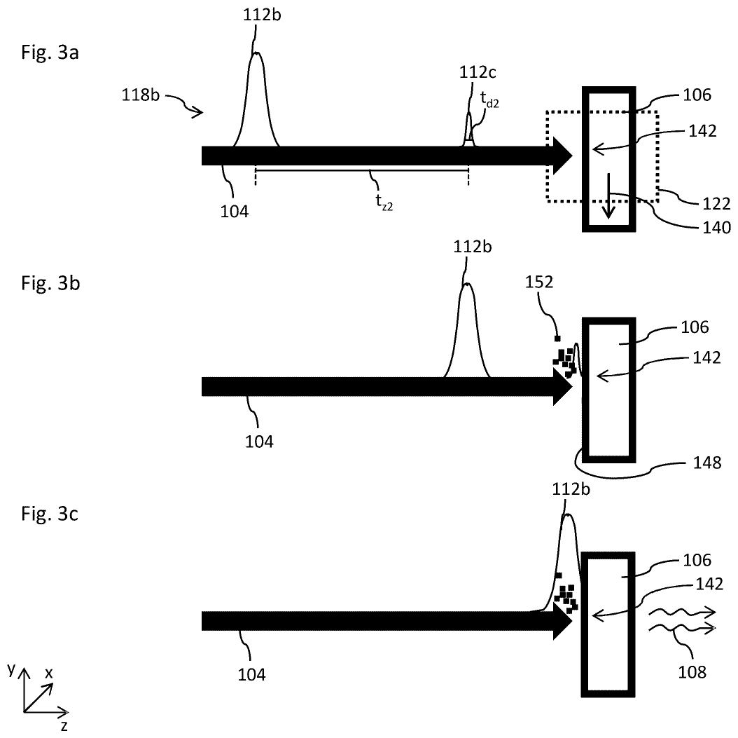

In the example shown in FIGS. 3a to 3c, a pulse sequence 118b, comprising a third laser pulse 112c and a second laser pulse 112b following the third laser pulse 112c, is applied to the target material 106.

A pulse duration t_{d2} of the third laser pulse 112c is, for example, between 800 fs and 1.5 ps.

A pulse energy of the third laser pulse 112c is, for example, between 10 μJ and 20 μJ.

A temporal pulse interval t_{z2} between the third laser pulse 112c and the second laser pulse 112b is, for example, between 10 ps and 100 ps.

The third laser pulses 112c are provided, for example, by means of the third laser source 110c. The third laser source 110c is then configured to provide third laser pulses 112c having the aforementioned properties.

The second laser pulse 112b has the properties mentioned above in connection with the example according to FIGS. 2a to 2c. It is possible, in principle, for the pulse sequence 118b to have a plurality of second laser pulses 112b.

Interaction of the third laser pulse 112c with the target material 106 causes nanoparticles 152 to form on the surface 148 of the target material 106, wherein the nanoparticles 152 are positioned in the spatial region 142 on the surface 148 in which the primary laser beam 104 is applied to the target material 106 and the target material 106 interacts with the third laser pulse 112c.

In this example, the third laser pulse 112c is referred to as the pre-pulse and the second laser pulse 112b as the main pulse of the pulse sequence 118b.

The formation of nanoparticles in materials through their interaction with laser pulses and the underlying physical effects are described, for example, in the above-mentioned scientific publication “Review on Experimental and Theoretical Investigations of Ultra-Short Pulsed Laser Ablation of Metals with Burst Pulses” by Förster et al., and in the scientific publication “Fs-ns double-pulse Laser Induced Breakdown Spectroscopy of copper-based alloys: Generation and elemental analysis of nanoparticles” by Guarnaccio et al., Spectrochimica Acta Part B 101 (2014) 261-268, https://doi.org/10.1016/j.sab.2014.09.011.

The average diameter of the nanoparticles 152 is between 10 nm and 100 nm.

It is also possible for a plurality of third laser pulses 112c to be provided to generate the nanoparticles 152 or for a pulse train consisting of a plurality of third laser pulses 112c to be provided.

FIG. 3c shows the interaction of the second laser pulse 112b with the target material 106 in the spatial region 142 of the formed nanoparticles 152, wherein secondary radiation 108 is generated by this interaction. Due to the presence of nanoparticles 152, secondary radiation 108 may be generated particularly efficiently by means of the second laser pulse 112b.

Due to the presence of the nanoparticles 152 in the region of the surface 148 of the target material 106, “plasmonic” resonances may occur, which cause particularly good absorption of the radiation of the main pulse in the electron gas of the target material 106 and, in particular, a particularly efficient increase in the electron temperature in the electron gas.

Similarly to the example according to FIGS. 2a to 2c, a movement velocity of the laser pulses 112c, 112b in the direction of the target material 106 is much greater than the flow velocity of the latter, such that all the laser pulses interact with the target material 106 approximately in the same spatial region 142.

In this example, too, it may be provided that the impact position 134 of the primary laser beam 104 on the target material 106 is adjusted by means of the control device 132 such that it remains constant, in particular between formation of the nanoparticles 152 and impact of the second laser pulse 112b. For this purpose, for example, a spatial position of the formed nanoparticles 152 is determined by means of the detection device 138 and, based thereon, the beam position of the primary laser beam 104 is adjusted by means of the beam deflection device 136.

It is possible to combine the variants described in FIGS. 2a to 2c and 3a to 3c. In particular, the pulse sequence 118 is then designed such that, through its interaction with the target material 106, an indentation 146 is first generated in a specific spatial region 142 and then nanoparticles 152 are generated in this spatial region 142. Subsequently, the secondary radiation 108 is generated by interaction of a main pulse in this region 142.

In this case, the pulse sequence 114 comprises, for example, the above-described pulse train 144 of first laser pulses 112a, the above-described third laser pulse 112c (see FIG. 1) or a pulse train as third laser pulses 112c and the above-described second laser pulse 112b. The pulse train 144 of first laser pulses 112a is here arranged chronologically before the third laser pulse 112c or the pulse train of third laser pulses 112c, and the third laser pulse 112c or the pulse train of third laser pulses 112c is arranged chronologically before the second laser pulse (i.e., it is the pulse train 144 of first laser pulses 112a that strikes the target material 106 first, followed by the third laser pulse 112c or the pulse train of third laser pulses 112c and finally the second laser pulse 112b). A time interval between the pulse train 144 of first laser pulses 112a, the third laser pulse 112c or pulse train of third laser pulses 112c and the second laser pulse 112b is in particular in each case between 1 ps and 500 ns.

The methods described allow incoherent X-ray radiation to be generated particularly efficiently as secondary radiation 108.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

td Pulse duration
t_{d2} Pulse duration
t_{g} Total temporal length
tᵢ Temporal pulse interval
t_{z} Temporal pulse interval
t_{z2} Temporal pulse interval
102 Laser device
104 Primary laser beam
104a First primary laser beam
104b Second primary laser beam
104c Third primary laser beam
106 Target material
108 Secondary radiation
110 Laser source
110a First laser source
110b Second laser source
110c Third laser source
112 Laser pulse
112a, c Laser pulse/pre-pulse
112′a Laser pulse/pre-pulse
112b Laser pulse/main pulse
114 Seed laser
116 Amplification device
118 Pulse sequence
118a, b Pulse sequence
120 Optical modulator
122 Target region
123 Focus
124 Focusing optics
126 Chamber
128 Feed device
130 Nozzle
132 Control device
134 Impact position
136 Beam deflection device
138 Detection device
140 Flow direction
142 Spatial region
144 Pulse train
146 Indentation
148 Surface
150 Depth direction
152 Nanoparticles

1. A method for generating secondary radiation, the method comprising:
providing a target material in a target region, and
applying a pulse sequence of laser pulses to the target material in the target region, wherein secondary radiation is generated as a result of interaction of the target material with the pulse sequence, wherein:
the pulse sequence has a pulse train of at least two pre-pulses and a main pulse following the pulse train,
a total energy of the pre-pulses of the pulse train is between 0.2 mJ and 10 mJ, and a temporal pulse interval between successive pre-pulses of the pulse train is between 50 ps and 500 ns,
a pulse energy of the main pulse is between 2 mJ and 50 mJ, and a pulse duration of the main pulse is between 15 fs and 300 fs, and
a temporal pulse interval between the pulse train and the main pulse is between 1 ns and 1 μs.

2. The method according to claim 1, wherein the total energy of the pre-pulses of the pulse train is between 0.5 mJ and 5 mJ, and/or the temporal pulse interval between successive pre-pulses of the pulse train is between 100 ps and 100 ns.

3. The method according to claim 1, wherein a total temporal length of the pulse train of the pre-pulses is between 1 ns and 10 μs.

4. The method according to claim 1, wherein application of the pulse train of the at least two pre-pulses to the target material causes formation of an indentation in the target material, wherein the indentation is positioned on a surface and/or in a spatial region of the target material in which the pulse train of the at least two pre-pulses is applied to the target material.

5. The method according to claim 1, wherein the pulse energy of the main pulse is between 5 mJ and 15 mJ, and/or the pulse duration of the main pulse is between 25 fs and 50 fs.

6. The method according to claim 1, wherein all the laser pulses of the pulse sequence are applied to the target material at a same location and/or in a same spatial region of the target material, and/or the main pulse is applied to the target material in a spatial region in which an indentation has been formed on a surface of the target material by the pulse train of the at least two pre-pulses.

7. The method according to claim 1, wherein, in the target region, a negative pressure and/or a vacuum and/or a gas atmosphere with a defined composition is formed.

8. The method according to claim 1, wherein the laser pulses of the pulse sequence are applied via at least one primary laser beam, wherein the at least one primary laser beam is provided by a laser device and is directed onto the target region in order to interact with the target material.

9. The method according to claim 8, wherein the at least one primary laser beam is focused into the target region, wherein a focus of the primary laser beam is positioned in the target material and/or on the target material and/or in a region of the target material.

10. The method according to claim 1, wherein the target material is continuously fed and/or conveyed into the target region.

11. The method according to claim 10, wherein the target material passes through the target region as a material stream, and/or the target material passes through the target region at a specific flow velocity and/or a conveying rate.

12. The method according to claim 10, wherein the pulse sequence of laser pulses is repeatedly newly provided and introduced into the target region, wherein a newly provided pulse sequence of laser pulses is applied to the target material newly introduced into the target region.

13. The method according to claim 1, wherein the pulse sequence of laser pulses has a further pre-pulse arranged between the pulse train of the at least two pre-pulses and the main pulse, wherein the further pre-pulse has a pulse duration of between 200 fs and 5 ps, and a pulse energy of between 2 μJ and 200 μJ.

14. The method according to claim 13, wherein the pulse duration of the further pre-pulse is between 800 fs and 1.5 ps, and/or the pulse energy of the further pre-pulse is between 5 μJ and 100 μJ.

15. The method according to claim 13, wherein a temporal pulse interval between the further pre-pulse and the main pulse is between 1 ps and 1 ns, and/or a temporal pulse interval between the further pre-pulse and the pulse train of the pre-pulses is between 0.5 ns and 500 ns.

16. The method according to claim 13, wherein application of the further pre-pulse to the target material causes formation of nanoparticles, wherein the nanoparticles are positioned in a region of a surface and/or in a spatial region of the target material in which the further pre-pulse is applied to the target material.

17. A laser system for generating secondary radiation, the laser system comprising:
a laser device configured to provide a pulse sequence of laser pulses, wherein:
the pulse sequence has a pulse train of at least two pre-pulses and a main pulse following the pulse train,
a total energy of the pre-pulses of the pulse train is between 0.2 mJ and 10 mJ, and a temporal pulse interval between successive pre-pulses of the pulse train is between 50 ps and 500 ns,
a pulse energy of the main pulse is between 2 mJ and 50 mJ, and a pulse duration of the main pulse is between 15 fs and 300 fs, and
a temporal pulse interval between the pulse train and the main pulse is between 1 ns and 1 μs,
wherein the laser system is configured to apply the pulse sequence of laser pulses to a target material in a target region, wherein secondary radiation is generated by interaction of the target material with the pulse sequence.
